(19) United States
(12) Patent Application Publication
(10) Pub. No.: US 2026/0122012 A1
(43) Pub. Date: Apr. 30, 2026

(54) CONFIGURATION OF SHARED BUFFERS WITH VIRTUAL OUTPUT QUEUES IN NOC ROUTERS

(71) Applicant: Baya Systems, Inc., Santa Clara, CA (US)

(72) Inventors: Joji PHILIP, San Jose, CA (US); Eric NORIGE, Santa Clara, CA (US); Jatinkumar Vithalbhai FULTARIA, Bengaluru (IN)

(73) Assignee: Baya Systems, Inc., (omitted)

(21) Appl. No.: 18/929,366

(22) Filed: Oct. 28, 2024

(30) Foreign Application Priority Data
Sep. 9, 2024 (IN) 202411068017

(51) Int. Cl. H04L 49/90; H04L 49/109

(52) U.S. Cl. CPC H04L 49/9036; H04L 49/109

(57) ABSTRACT

A Network on Chip (NoC) includes a plurality of shared buffers configured to manage arriving flits with a plurality of logical queues, each of the plurality of logical queues configured to manage the arriving flits according to a virtual channel of an input port associated with the arriving flits and an output port corresponding to the arriving flits. A first set of arbitration logic is configured to output arbitration of flits from the plurality of logical queues to a second set of arbitration logic. The second set of arbitration logic is configured to arbitrate output flits from the first set of arbitration logic to the output port. Additionally, the configuration of the shared buffers with two-set of arbitration logic provides efficient arbitration of data transmission.

### CROSS-REFERENCE TO RELATED APPLICATIONS

This application claims priority to IN 202411068017, filed on Sep. 9, 2024, the contents of which are incorporated herein by reference.

### BACKGROUND

### Technical Field

Methods and example embodiments described herein are generally directed to the configuration of shared buffers in Network on Chip (NoC), and more specifically, to enhancing arbitration performance in NoC switches through the use of shared buffers and virtual output queues.

### Related Art

The number of components on a chip is rapidly growing due to increasing levels of integration, system complexity, and shrinking transistor geometry. Complex System-on-Chips (SoCs) may involve a variety of components e.g., processor cores, Digital Signal Processors (DSPs), hardware accelerators, memory, and Input/Output (I/O) interfaces, while Chip Multi-Processors (CMPs) may involve a large number of homogenous processor cores, memory, and I/O subsystems. In both systems, the on-chip interconnect plays a key role in providing high-performance communication between the various components. Due to scalability limitations of traditional buses and crossbar-based interconnects, Network-on-Chip (NoC) has emerged as a paradigm to interconnect a large number of components on the chip.

NoC is a global shared communication infrastructure made up of several routing nodes interconnected with each other using point-to-point physical links. Messages are injected by source components and are routed from the source components to a destination component over multiple intermediate nodes and physical links. The destination component then ejects the message and provides it to other components associated with the destination component. For the remainder of the document, the terms ‘processing elements,’ ‘components,’ ‘blocks,’ ‘hosts,’ or ‘cores,’ will be used interchangeably to refer to the various system components which are interconnected using a NoC. The terms ‘routers’ and ‘nodes’ will also be used interchangeably. Without loss of generalization, the system with multiple interconnected components will itself be referred to as a ‘multi-core system.’

There are several possible topologies in which the routers can connect to one another to create the system network. Bi-directional rings 100A (as shown in FIGS. 1A) and 2-D mesh 100B (as shown in FIG. 1B) are examples of topologies in the related art.

Packets are message transport units for intercommunication between various components. Routing involves identifying a path which is a set of routers and physical links of the network over which packets are sent from a source to a destination. Components are connected to one or multiple ports of one or multiple routers; with each such port having a unique identifier (ID). Packets carry the destination's router and port ID for use by the intermediate routers to route the packet to the destination component.

Examples of routing techniques include deterministic routing, which involves choosing the same path from A to B for every packet. This form of routing is oblivious to the state of the network and does not load balance across path diversities which may exist in the underlying network. However, such deterministic routing may be simple to implement in hardware, maintains packet ordering, and may be easy to make free of network-level deadlocks. Shortest path routing minimizes the latency as it reduces the number of hops from the source to the destination. For this reason, the shortest path is also the lowest power path for communication between the two components. Dimension-order routing is a form of deterministic shortest-path routing in 2D mesh networks.

FIG. 2 illustrates an example of XY routing in a two-dimensional mesh 200. More specifically, FIG. 2 illustrates XY routing from node ‘34’ to node ‘00.’ In the example of FIG. 2, each component is connected to only one port of one router. A packet is first routed in the X dimension till the packet reaches node ‘04’ where the x dimension is the same as the destination. The packet is next routed in the Y dimension until the packet reaches the destination node.

Source routing and routing using tables are other routing options used in NoC. Adaptive routing can dynamically change the path taken between two points on the network based on the state of the network. This form of routing may be complex to analyze and implement and is therefore rarely used in practice.

NoC may contain multiple physical networks. Over each physical network, there may exist multiple virtual networks, where different message types are transmitted over different virtual networks. In this case, at each physical link or channel, there are multiple virtual channels (VCs), and each VC may have dedicated buffers at both endpoints. In any given clock cycle, only one VC can transmit data on the physical channel.

NoC interconnects often employ wormhole routing, where a large message or packet is broken into small pieces known as flits (also referred to as flow control digits). The first flit is the header flit which holds information about the packet's route and key message level information along with payload data and sets up the routing behavior for all subsequent flits associated with the message. Zero or more body flits follow the head flit, containing the remaining payload of data. The final flit is a tail flit which in addition to containing the last payload also performs some bookkeeping to close the connection for the message. In wormhole flow control, VCs are often implemented.

The physical channels are time-sliced into a number of independent logical channels, i.e. VCs. VCs provide multiple independent paths to route packets; however, they are time-multiplexed on the physical channels. A VC holds the state needed to coordinate the handling of the flits of a packet over a channel. At a minimum, this state identifies the output channel of the current node for the next hop of the route and the state of the virtual channel (idle, waiting for resources, or active). The VC may also include pointers to the flits of the packet that are buffered on the current node and the number of flit buffers available on the next node.

The term “wormhole” refers to the way messages are transmitted over the channels: the output port at the next router can be so short that received data can be translated in the head flit before the full message arrives. This allows the router to quickly set up the route upon arrival of the head flit and then opt-out from the rest of the conversation. Since a message is transmitted flit by flit, the message may occupy several flit buffers along its path at different routers, creating a worm-like image.

Based on the traffic between various endpoints, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies. However, all channels are equal in width or number of physical wires. This width can be determined based on the most loaded channel and the clock frequency of various channels.

### SUMMARY

Aspects of the example implementations may include a Network on Chip (NoC) that includes a plurality of shared buffers, each of the shared buffers corresponding to each input port of a router in the NoC, each of the shared buffers configured to manage arriving flits with a plurality of logical queues, each of the plurality of logical queues configured to manage the arriving flits according to a virtual channel of the input port associated with the arriving flits and an output port associated with the arriving flits. A first set of arbitration logic is configured to output arbitration of flits from the plurality of logical queues to a second set of arbitration logic, wherein the first set of arbitration logic arbitrates per input port and per output port. The second set of arbitration logic is configured to arbitrate output flits from the first set of arbitration logic to the output port, wherein the second set of arbitration logic arbitrates per output port among flits from the output of the first set of arbitration logic at the input ports.

Additional aspects of the example implementations may include a method for a NoC, the method including managing arriving flits with a plurality of shared buffers, each of the shared buffers corresponding to each input port of a router in the NoC, each of the shared buffers configured to manage the arriving flits with a plurality of logical queues, each of the plurality of logical queues managing the arriving flits according to a virtual channel of the input port associated with the arriving flits and an output port associated with the arriving flits. Further, the method includes outputting arbitration of flits from the plurality of logical queues from a first set of arbitration logic to a second set of arbitration logic, wherein the first set of arbitration logic arbitrates per input port and per output port, and arbitrating output flits from the first set of arbitration logic to the output port through the second set of arbitration logic, wherein the second set of arbitration logic arbitrates per output port among flits from the output of the first set of arbitration logic at the input ports.

### BRIEF DESCRIPTION OF THE DRAWINGS

FIGS. 1A and 1B illustrate examples of Bi-directional ring and 2D Mesh Network on Chip (NoC) topologies.

FIG. 2 illustrates an example of XY routing in a NoC having a two-dimensional mesh topology.

FIG. 3 illustrates a schematic representation of a configuration of shared buffers along with a two-set of arbitration logic within a NoC, in accordance with an example implementation.

FIG. 4 illustrates a flowchart of a method of transmission of flits within a NoC router, in accordance with an example implementation.

FIGS. 5A-5D illustrate flowcharts of a method of credit management, in accordance with an example implementation.

FIG. 6 illustrates a computer/server block diagram upon which the example implementations described herein may be implemented.

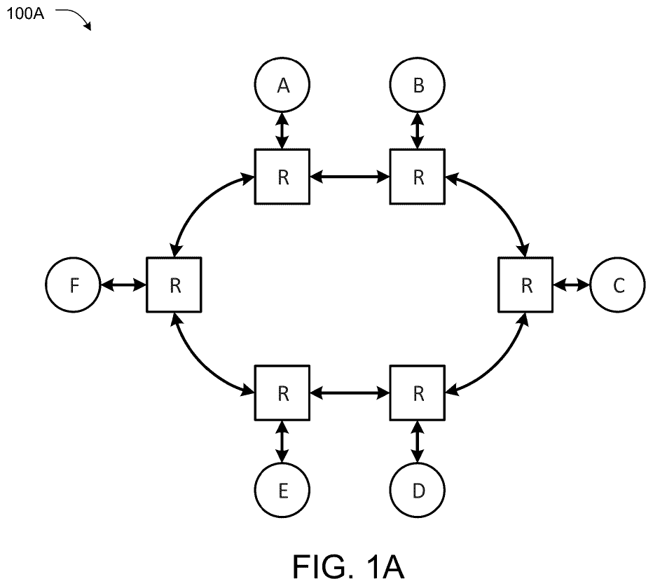

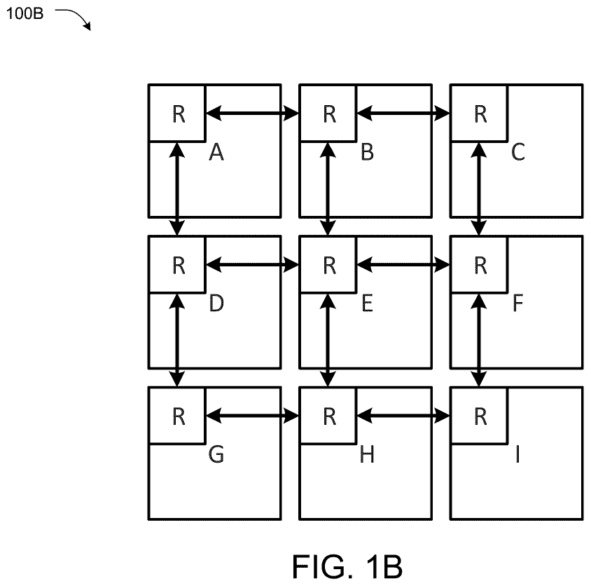

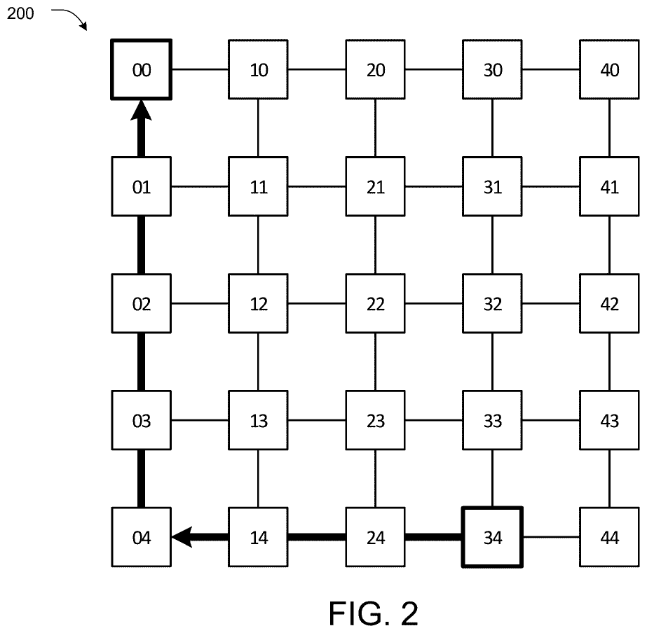

### DETAILED DESCRIPTION

In existing Network on Chip (NoC) systems, when multiple packets arrive at a NoC router from different source components, the multiple packets are temporarily stored in buffers. This buffer is shared among various packets that enter the NoC router. Each packet contains information that specifies an output port on the NoC router to reach a destination component. Once packets enter the buffer of the NoC architecture, each packet is organized into queues. Each packet waits for an opportunity to move to an assigned output port. In some scenarios, when multiple packets target the same output port simultaneously, it leads to a complex situation, for example, to handle the multiple packets at the same time. To manage this situation, NoC uses an arbitration mechanism that decides which packet has to move forward in each cycle. When packets going to multiple output ports of a router are organized into the same queue, it leads to inefficiencies and bandwidth constraints because only the packet at the head of the queue participates in the arbitration, potentially causing other packets that may have been routed to less contested outputs to wait unnecessarily. This inefficiency becomes more severe when traffic is evenly distributed across all outputs. This results in bottlenecks, lowering the performance of the NoC system. Consequently, there is low bandwidth usage and an increased potential for data loss and delays. Additionally, the available bandwidth is not fully utilized due to contention in the buffers.

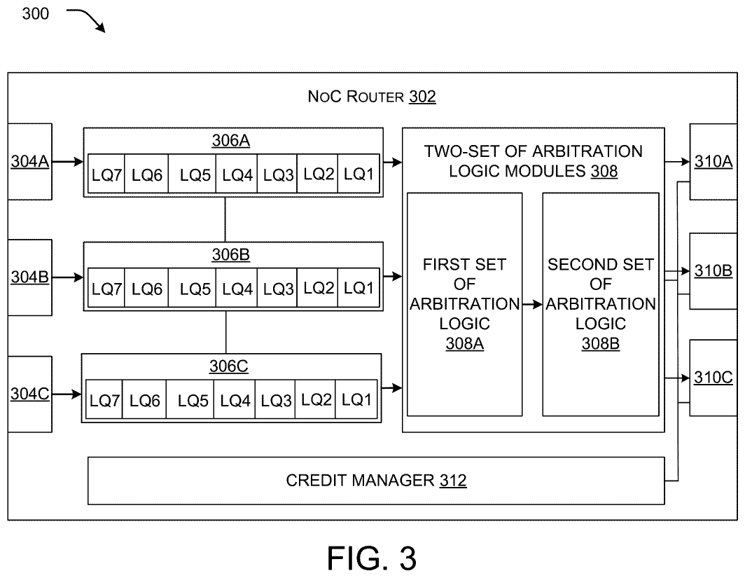

Like the existing NoC systems, the present NoC may include routers multiple input ports. Each input port may be provided with a dedicated shared buffer. The dedicated shared buffers may be configured with logical queues organized according to Virtual Channels (VCs) and output ports. Such configuration may ensure that data traffic is efficiently prioritized and directed, mitigating congestion and reducing latency. Moreover, a two-set of arbitration logic further enhances performance. A first set of arbitration logic may operate on a per-input port and per-output port basis to facilitate the sorting of flits according to a VC of the input port and the corresponding output port. Subsequently, the second set of arbitration logic may complete the process by arbitrating among flits from the input ports on a per-output port basis. The dynamic arbitration mechanism may optimize the transmission sequence, maximizing throughput. Additionally, the dynamic arbitration mechanism may ensure the distribution of network bandwidth among various components of the system, thereby enhancing its overall efficiency. Various embodiments of the present disclosure will be explained in detail with respect to FIGS. 3-6.

FIG. 3 illustrates a schematic representation 300 of a configuration of shared buffers along with a two-set of arbitration logic within a NoC router 302, in accordance with an example implementation.

NoC is a communication infrastructure used within integrated circuits such as Central Processing Units (CPUs,), Graphical Processing Units (GPUs), or System on Chips (SoCs) to facilitate communication between different components or cores. Further, NoC may serve as a network within a chip, allowing data packets to be transferred efficiently between various processing elements. The major switching element within the NoC is often called a router, which takes packets in from various sources, buffers them, and sends them out towards their destination. Referring to FIG. 3, NoC router 302 may include a plurality of input ports 304A, 304B, and 304C (collectively referred to as 304), a plurality of shared buffers 306A, 306B, and 306C (collectively referred to as 306), a plurality of output ports 310A, 310B, and 310C (collectively referred to as 310), a two-set of arbitration logic modules 308, and a credit manager 312.

In an embodiment, each input port 304 may serve as an interface through which data packets are received from source components/cores such as processors, controllers, other routers, and the like and transmit the data packets to destination components/cores such as memory units, other routers, and the like. For example, each source core has its own input port 304 connected to the NoC router 302 and each input port 304 may be associated with a shared buffer 306. In an embodiment, each shared buffer 306 may be configured corresponding to each input port 304 of the NoC router 302. For example, a first shared buffer 306A is configured corresponding to a first input port 304A. Similarly, the second and third shared buffers 306B and 306C are configured corresponding to second and third input ports 304B and 304C. Each shared buffer 306 may handle data traffic received from a particular input port 304 of the NoC router 302. Each shared buffer 306 may act as a temporary storage unit to accommodate pieces of incoming data packets, known as flits. The name “flit” comes from the phrase flow control unit. For example, when the data packets are transmitted from a source component/core to a destination component/core through a NoC router 302, the data packets may be segmented as flits, for example, by adding headers for each flit. The header may contain details such as, but not limited to, a destination address, a source address, sequence numbers, and other control information required for accurate transmission and routing across a network. Once the data packets are segmented as flits, the flits may be temporally stored in a corresponding shared buffer 306 associated with the particular input port 304.

In an embodiment, each of the shared buffers 306 may be configured to manage arriving flits with Virtual Output Queues (VOQs) also known as a plurality of logical queues represented as LQ1 to LQ7, in FIG. 3. In an embodiment, each of the plurality of logical queues may be configured to manage the arriving flits according to a VC of the input port 304 associated with the arriving flits and an output port 310 corresponding to the arriving flits. In exemplary embodiments, each logical queue LQ1 to LQ7 may be a data structure in each shared buffer 306. Each logical queue LQ1 to LQ7 may be responsible for organizing and managing the incoming flits within the NoC router 302. In exemplary embodiments, each logical queue LQ1 to LQ7 may organize the incoming flits based on certain criteria such as, but not limited to, a destination core, a priority of the flits, Quality of Service (QoS) requirements, and the like. In an embodiment, each logical queue may manage the arriving flits according to the VC associated with the input ports 304 and the output ports 310. In an embodiment, VCs may serve as logical communication pathways within the NoC router 302. Each logical queue LQ1 to LQ7 within each shared buffer 306 may route the incoming flits based on the VC associated with the flits, thereby ensuring efficient and prioritized communication between the source component(s) and the destination component(s). In an embodiment, multiple VCs may be configured within a single physical link (e.g., the input port 304), allowing for improved performance and reduced contention. Each input port 304 may be considered to have multiple VCs, with each VC potentially targeting one or more output ports 310. For example, each input port 304 of the NoC router 302 may have multiple VCs, representing different types of traffic or priority levels. One VC may be dedicated for high-priority data, while another VC may be dedicated for low-priority background tasks. In exemplary embodiments, the shared buffers 306 may eliminate the need for dedicated First Input First Output (FIFO) buffers for each virtual channel, thereby reducing resource overhead and simplifying the arbitration process.

In exemplary embodiments, upon arrival of the flits at the input port (e.g., 304A), the flits are temporarily stored in the corresponding shared buffer (e.g., 306A) before undergoing arbitration and selection processes. Within the shared buffer 306A, multiple logical queues (LQ1 to LQ7) are configured to manage the incoming flits based on their priority, destination virtual channels (VCs), and output ports 310. For example, when core A transmits high-priority flits to the input port 304A, the high-priority flits are directed to logical queue LQ1 corresponding to VC0 and the output port 310A leading to the destination component (e.g., the memory unit). Similarly, low-priority flits from core A are stored in logical queue LQ6 corresponding to VC1 and the output port 310B. The use of multiple logical queues may ensure efficient routing and prioritization of flits within the shared buffer 306, optimizing the performance of the NoC router 302.

In an embodiment, once the flits are accommodated in the logical queues (LQ1 to LQ7) based on, for example, the priority of the flits, the VC, and the output port 310, the two-set of arbitration logic modules 308 may perform an arbitration process. As shown, the two-set of arbitration logic modules 308 may include a first set of arbitration logic 308A and a second set of arbitration logic 308B. Initially, the first set of arbitration logic 308A may be configured to output arbitration of the flits from the plurality of logical queues to the second set of arbitration logic 308B. In an embodiment, the first set of arbitration logic 308A may arbitrate per-input port and per-output port. In an embodiment, the second set of arbitration logic 308B may be configured to arbitrate output flits from the first set of arbitration logic 308A to the output ports 310. In an embodiment, the second set of arbitration logic 308B may arbitrate per-output port among flits from input ports. In exemplary embodiments, the second set of arbitration logic 308B may be configured to begin arbitration before the first set of arbitration logic 308A is completed.

In an exemplary embodiment, the first set of arbitration logic 308A may manage the flow of flits (flow control units) within the NoC router 302. The first set of arbitration logic 308A may be responsible for selecting the flits from the plurality of logical queues LQ1 to LQ7, which are associated with different input ports 304, and forwarding the flits to the second set of arbitration logic 308B. The first set of arbitration logic 308A processes may occur independently for each input port 304 and each output port 310, ensuring that the selection of the flits is performed efficiently. For example, when several cores (core A, core B, core C, and so on) are simultaneously accessing a shared memory module via the NoC router 302, each core may be represented by different input ports (304A, 304B, 304C), and has pending flits that need to be transmitted to the memory module, represented by the output port 310. In this scenario, if core A requires frequent memory accesses to fetch and store data, and if core B is actively engaged with the memory module for read and write operations, then the first set of arbitration logic 308A may independently manage the flow of flits from each core, ensuring efficient selection of the flits. For example, core A, core B, and core C, each may have their respective logical queues (LQ1, LQ2, LQ3) within the shared buffers 306, organizing the incoming flits based on their source address and destination address provided in the header of each flit. In an embodiment, the first set of arbitration logic 308A may prioritize access to the memory module based on predefined criteria such as priority, QoS requirements, and the like. For example, if core A has critical flits that need immediate access to the memory module, the first set of arbitration logic 308A may ensure that the flits from core A are prioritized accordingly. In an embodiment, once the first set of arbitration logic 308A selects the appropriate flits from the logical queues of each core, the first set of arbitration logic 308A may forward the flits to the second set of arbitration logic 308B for further processing. This may ensure that the flits are efficiently transmitted to the memory module without contention issues or unnecessary delays, maximizing the overall performance of the system.

In exemplary embodiments, the second set of arbitration logic 308B may begin the arbitration process before the completion of the first set of arbitration logic 308A. This may ensure that the arbitration process is initiated promptly, even if there are ongoing arbitration decisions being made by the first set of arbitration logic 308A. By allowing the second set 308B to start arbitration logic prior to completion of the process by the first set 308A, potential delays in the overall transmission process are minimized and the overall efficiency of the NoC router 302 is enhanced. For example, if the first set of arbitration logic 308A is still processing the flits for one input port (e.g., 304A), the second set of arbitration logic 308B may start evaluating and arbitrating the flits from other input ports (e.g., 304B or 304C) destined for different output ports 310. This concurrent arbitration may maximize the utilization of the available bandwidth and reduce latency in data transmission.

In an embodiment, the two-set of arbitration logic modules 308 may receive the flits from multiple input ports 304, each associated with several VCs. Traditionally, the NoC may handle arbitration for all incoming packets in a serial manner, evaluating priority of each packet and deciding the order of transmitting the packet to the output port. In accordance with embodiments of the present disclosure, the two-set of arbitration logic modules 308 may divide the arbitration process into smaller, parallel operations. For example, if the NoC router 302 has three input ports (304A, 304B, 304C), each connected to two VCs, and two output ports; instead of sequentially evaluating all incoming flits for each output port 310, the two-set of arbitration logic modules 308 may perform the arbitration process in parallel. Each input port 304 may independently determine the best candidate flit for transmission to a specific output port 310, based on factors like priority, the QoS requirements, or available bandwidth. This parallel arbitration approach may significantly reduce the time required for arbitration and enable faster decision-making. In some scenarios, if the input port 304 has multiple flits destined for different output ports 310, parallel arbitration may allow each flit to be evaluated simultaneously. As a result, the two-set of arbitration logic modules 308 may efficiently allocate resources and minimize contention delays, leading to improved overall network performance and throughput. By breaking down arbitration into smaller, parallel operations, the two-set of arbitration logic modules 308 can handle data traffic more efficiently, ensuring optimal utilization of NoC resources.

In an embodiment, when arbitration is performed per-input port, the first set of arbitration logic 308A may consider the incoming flits from each individual source or input port 304 separately. The first set of arbitration logic 308A may determine which packets from a particular input port 304 should be prioritized or granted access to proceed further within the NoC router 302. For example, the arbitration per-input port 304 may involve deciding which data packets from core A, core B, core C, etc., should be allowed to move forward based on factors like priority, the QoS requirements, and the like.

In some embodiments, conversely, when arbitration is performed per-output port 310, the second set of arbitration logic 308B may consider the outgoing destination output ports 310 within the NoC router 302. The second set of arbitration logic 308B may determine which packets should be sent to a particular output port 310 based on the availability of resources and the priority of data traffic destined for that output port 310. For example, if there are multiple destinations such as memory unit, peripheral 1, peripheral 2, etc., each corresponding to a different output port 310, arbitration per-output port 310 may involve deciding which data packets should be forwarded to memory, which packets should be forwarded to peripheral 1, and so on, based on factors like priority, the QoS requirements, bandwidth allocation, and the like.

In some exemplary embodiments, when core A needs to transmit the flits to the memory unit and core B needs to transmit the flits to a peripheral, the shared buffers 306 may temporarily store the flits received from core A and core B. The first set of arbitration logic 308A may decide which flits get to move forward based on their source address and destination address provided in their respective header. For example, if the flits from core A destined for the memory unit may get priority over the flits from core B to the peripheral 1, then the second set of arbitration logic 308B may prioritize the access of the flits from core A to the output ports 310. If the memory unit and peripheral 1 share the same output port (e.g., 310B), the second set of arbitration logic 308B may decide which flits need to be sent first based on various factors such as priority, QoS, and the like.

In exemplary embodiments, the credit manager 312 may be configured to regulate the flow of the flits across various channels by storing credits received at the output ports 310 and making credit (and thus output buffer) availability information available to the arbitration logic modules 308. When a flit is transmitted, it is necessary to decrement a credit counter to account for the space that flit will take in the destination buffer. When a flit is popped from a buffer, a credit return message will be sent upstream. The credit return message must trigger an increment in a credit counter in that upstream router. With shared storage across VCs, there is a choice to be made for both increment and decrement. When both shared and dedicated credits are available, either could be decremented on transmission, and when both shared and dedicated credits are not at their maximum value, either could be incremented on credit return.

In an embodiment, the credit manager 312 may be configured to, upon receipt of a return credit for a flit associated with the VC, if the return credit is associated with a locked VC and if dedicated credits for the associated VC are zero, increment the dedicated credits for the associated VC. For example, when the flits are transmitted from one component to another component within the NoC router 302, the flits may consume a certain number of credits. Upon successful delivery of the flits from one component to another component, the input ports 304 may generate a return credit, thereby indicating that the resources used for transmitting the flits are now available again. Upon receiving the return credit for the flits associated with a particular VC, the credit manager 312 may initiate proper credit management. In an embodiment, the credit manager 312 may first check whether the VC associated with the return credit is locked or not. If the VC associated with the return credit is locked, it may be understood that the locked VC is currently reserved for a specific communication task and the locked VC may not be used by another component until the locked VC gets unlocked. Additionally, the credit manager 312 may verify whether the dedicated credits for the associated VC are zero or not. The dedicated credits may represent the available resources allocated specifically to that virtual channel for transmitting flits. In an embodiment, if the VC is locked and the dedicated credits of the VC are zero, then the credit manager 312 may proceed to increment the dedicated credits for that particular VC. This may ensure that progress can be made on the specific communication task that the VC was locked for.

For example, where multiple processing cores communicate with each other and with peripheral devices, each core may have its dedicated VCs for transmitting the flits. When core A sends the flits to core B or a peripheral, core A may consume credits from the associated VC. Upon successful delivery of the flit, the return credit is generated. In some scenarios, if core A sends the flits to core B using a specific VC, e.g., VC1, after successful transmission of the flit, the return credit associated with VC1 is generated. If VC1 is currently locked for a critical communication task and has exhausted its dedicated credits, the credit manager 312 may prefer to increment dedicated credits for VC1 on credit return, making VC1 available for upcoming transmissions between core A and core B. This may ensure that communication between the cores can continue smoothly without resource depletion issues. In exemplary embodiments, when multiple VCs contend for the same output port 310, the arbitration process may prioritize and schedule the transmission of the flits to avoid deadlocks.

In an embodiment, the credit manager 312 may be configured to manage shared credits within the VC setup. In case of shared credits of the VC associated with the return credit being greater than zero, the credit manager 312 may increment the shared credit. In exemplary embodiments, upon receiving the return credit for the flits associated with a specific VC, the credit manager 312 may be triggered to execute a sequence of operations. The execution of these operations may be directed by predefined conditions determined by a state of the credits of the VC. For example, where multiple processing units access a shared resource, such as a memory module, via the VCs, each processing unit may be assigned a specific number of shared credits to access the shared resource. In some scenarios, the processing unit A may transmit the flit requesting access to the shared resource. Upon completion of the transmission, the return credit may be issued by the input ports 304 and directed back to access the VC of processing unit A. If the processing unit A still keeps an unused shared credit associated with the VC, the credit manager 312 may proceed to increment the shared credit count. This increment of the shared credits may effectively provide the processing unit A with additional access to the shared resource. In exemplary embodiments, conversely, in case the VC of the processing unit A consumes its shared credits (i.e., the count is zero), indicating that the processing unit A has utilized its allotted credits, the credit manager 312 may decrease the shared credit count associated with the VC.

In an embodiment, the credit manager 312 may be configured to increment the dedicated credit for the associated VC when the shared credits of the VC are zero. In exemplary embodiments, when the shared credits of the VC diminish to zero, then the credit manager 312 may indicate an exhaustion of the shared credits. In response to this scenario, the credit manager 312 may initiate an increase in the dedicated credit allocated to the affected VC. In an embodiment, the extension of dedicated credit(s) may ensure that the VC may retain the necessary resources for continued operation, even in the absence of shared credits. By incrementing the dedicated credit, the credit manager 312 may effectively sustain the transmission capabilities of the VC, thereby protecting the overall functionality and performance of the NoC router 302.

Considering an example scenario where a sudden surge in data traffic happens from one processor to a memory module, the VC between the processor and the memory module becomes congested, and the shared credits allocated for this VC get used up quickly. In this scenario, the credit manager 312 may detect congestion in the particular VC between the processor and the memory module. Since the shared credits for the VC are running low, the credit manager 312 may increase the dedicated credits specifically assigned to the VC between the processor and the memory module. By adding more dedicated credits, the credit manager 312 may ensure that the transmission of flits between the processor and the memory module remains efficient and uninterrupted, even during periods of high traffic and limited shared resources within the NoC router 302. This optimization may maintain the overall performance and reliability of the NoC router 302.

In exemplary embodiments, the credit manager 312 may be configured with various predefined criteria for consuming credits. The credit manager 312 may determine whether to prioritize the utilization of the shared credits or the dedicated credits. The credit manager 312 may select between these policies depending on various factors such as system architecture, traffic patterns, and performance requirements. In an embodiment, the shared credits may refer to a pool of credits accessible to multiple cores within the NoC router 302, while dedicated credits are specifically allocated to individual cores. In exemplary embodiments, the credit manager 312 may operate in two modes. In a first mode, the credit manager 312 may prioritize the consumption of the shared credits over the dedicated credits. In the first mode, the NoC router 302 may maximize the utilization of shared resources, providing equal access among different components within the NoC router 302. This approach may align with the principles of resource sharing and can enhance overall system efficiency in scenarios where traffic patterns are dynamic and unpredictable. In a second mode, the credit manager 312 may prioritize the consumption of the dedicated credits over the shared credits. In the second mode, the credit manager 312 may provide dedicated resources for critical transactions, ensuring low latency and guaranteed bandwidth for high-priority tasks.

Therefore, referring to FIG. 3, each buffer 306 is configured corresponding to the input port 304. These shared buffers 306 may be essential for temporarily storing the arriving flits before the flits are transmitted further through the NoC router 302. Additionally, each shared buffer 306 may be configured with multiple logical queues (LQ1 to LQ7), ensuring efficient management of the incoming flits based on their associated VCs and the output ports 310. For example, where the flits from different cores need to be transmitted to various destinations like memory modules or peripheral devices, each core corresponds to the input port 304, and the shared buffers 306 temporarily store the flits from these cores before onward transmission.

In an embodiment, the first set of arbitration logic 308A may be responsible for managing the arbitration of the flits from the logical queues to the second set of arbitration logic 308B. The first set of arbitration logic 308A may operate per-input port and per-output port, ensuring efficient selection of the flits for transmission. For example, where multiple cores are simultaneously sending the flits to the memory module, the first set of arbitration logic 308A may prioritize these flits based on predefined criteria, such as priority, the QoS requirement, and the like, before forwarding the flits to the next stage of arbitration (e.g., 308B).

In an embodiment, once the second set of arbitration logic 308B receives the output flits from the first set of arbitration logic 308A, the second set of arbitration logic 308B may arbitrate the output flits to the output port 310. This second set of arbitration logic 308B may operate per-output port, ensuring that flits from different input ports 304 are transmitted to the output port 310 in an orderly manner. For example, if the memory module (e.g., the destination component) is receiving the flits from multiple cores, the second set of arbitration logic 308B may determine the order in which these flits are transmitted to the output port 310 of the memory module, maintaining efficient utilization of the output bandwidth.

In an embodiment, the credit manager 312 may manage the credits associated with the VC which enables the transaction between the source component and the destination component. When the credit manager 312 receives the return credit for the flits associated with the VC, the credit manager 312 may adjust the dedicated and shared credits associated with that particular VC, ensuring proper resource allocation within the NoC router 302. For example, when there is congestion in the VC due to heavy data traffic, the credit manager 312 may detect the congestion and adjust the shared and dedicated credits accordingly to prevent congestion and maintain smooth flits transmission.

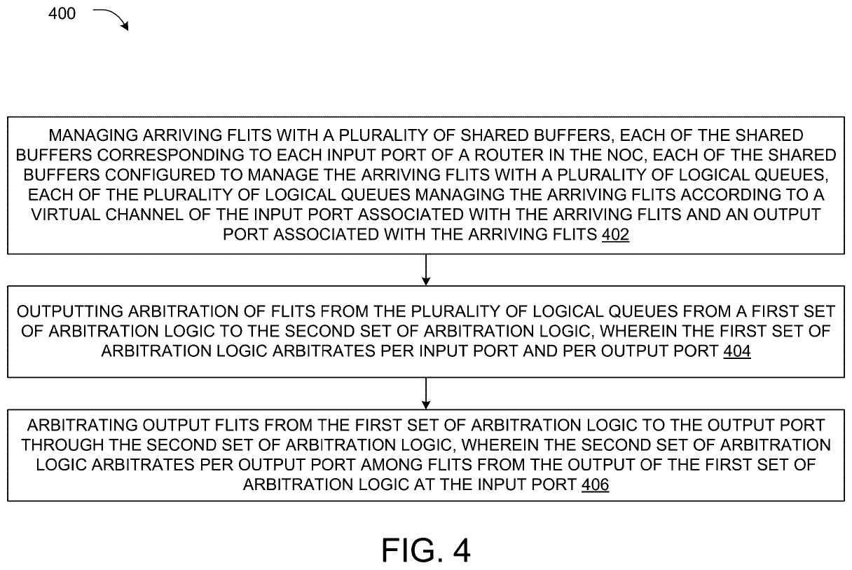

FIG. 4 illustrates a flowchart of a method 400 of transmission of flits within a NoC router (e.g., 302), in accordance with an example implementation.

Referring to FIG. 4, at 402, the method 400 may include managing arriving flits with a plurality of shared buffers (e.g., 306), each of the shared buffers 306 corresponding to each input port (e.g., 304) of the NoC router (e.g. 302), each of the shared buffers 306 configured to manage the arriving flits with a plurality of logical queues, each of the plurality of logical queues managing the arriving flits according to a VC of the input port 304 associated with the arriving flits and an output port 310 associated with the arriving flits.

At 404, the method 400 may include outputting arbitration of flits from the plurality of logical queues from a first set of arbitration logic (e.g., 308A) to a second set of arbitration logic (e.g., 308B). The first set of arbitration logic (e.g., 308A) may arbitrate per-input port and per-output port. At 406, the method 400 may include arbitrating output flits from the first set of arbitration logic 308A to the output port 310 through the second set of arbitration 308B. The second set of arbitration logic 308B may arbitrate per-output port among flits from input ports 304.

In an embodiment, the second set of arbitration logic 308B may be configured to begin arbitration prior to the completion of arbitration by the first set of arbitration logic 308A. In an embodiment, on receipt of a return credit for a flit associated with a VC for the return credit being associated with a locked VC and for dedicated credits for the associated VC being zero, the method 400 may include incrementing the dedicated credits for the associated VC. In an embodiment, for shared credits of a VC associated with the return credit being greater than zero, the method 400 may include incrementing a shared credit and decrementing the shared credits of the associated VC. In an embodiment, for the shared credits of the VC being zero, the method 400 may include incrementing a dedicated credit for the associated VC.

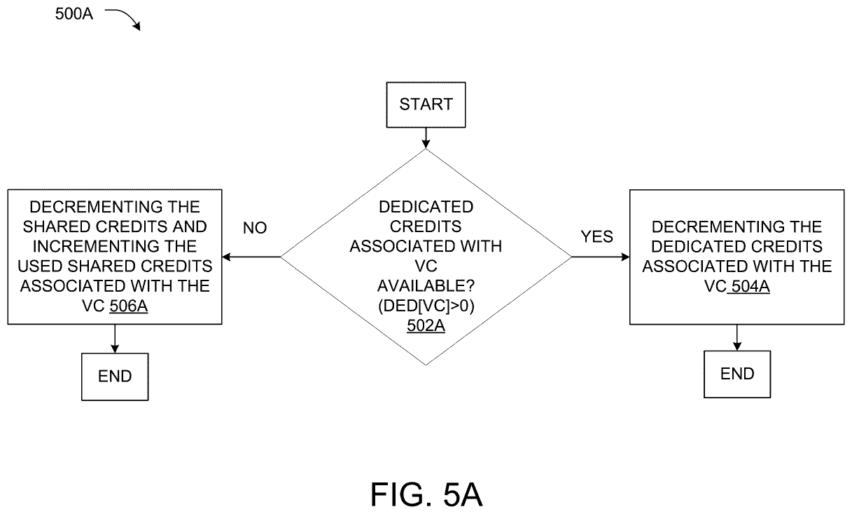

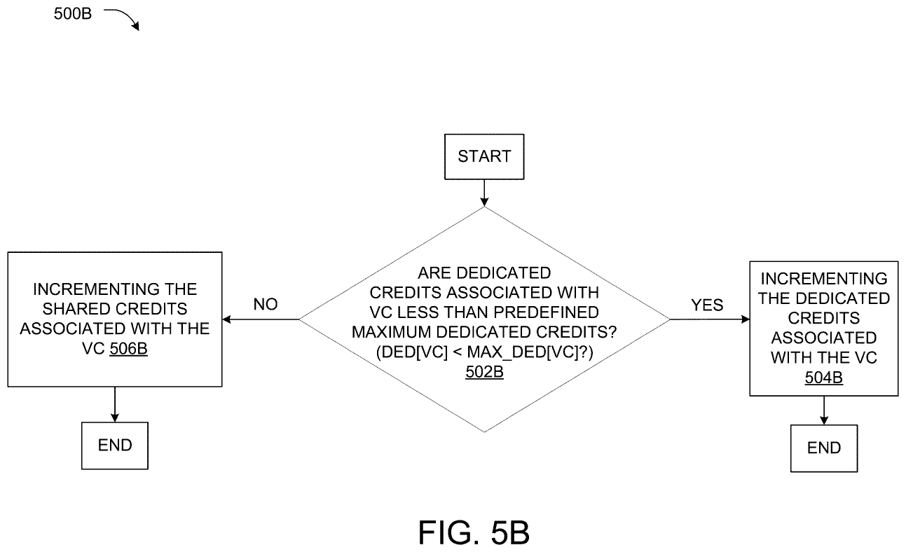

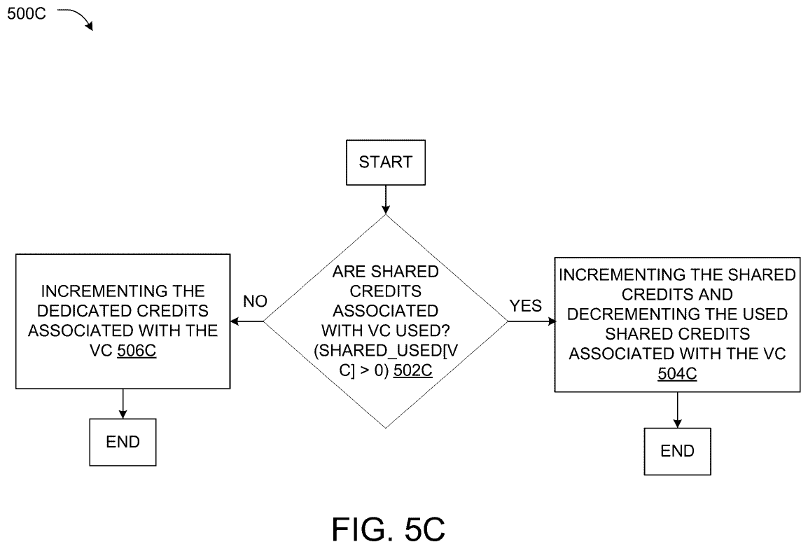

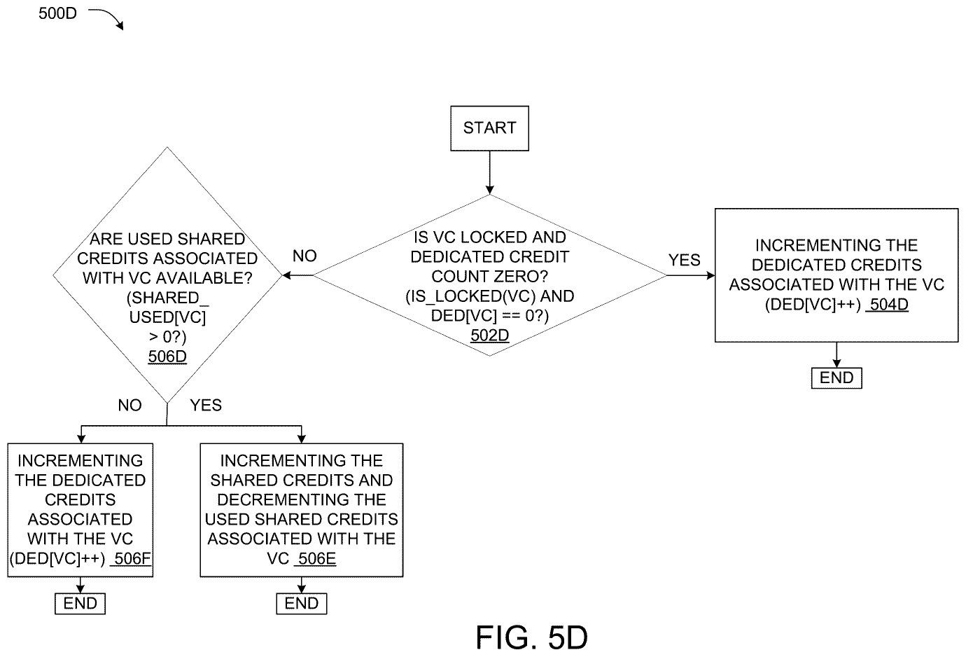

FIGS. 5A-5D illustrate flowcharts of methods (500A, 500B, 500C, and 500D) of credit management, in accordance with an example implementation. FIG. 5A illustrates a method 500A for consuming credits from a specific VC. Referring to FIG. 5A, at 502A, the credit manager (e.g., 312) may check whether dedicated credits associated with a VC are available or not (ded[VC]>0?). If the dedicated credit associated with the VC is available, the credit manager 312 may decrement the dedicated credits associated with the VC, as represented at 504A. At 506A, if the dedicated credit associated with the VC is not available, the credit manager 312 may decrement shared credits and increment used shared credits associated with the VC. For example, in some scenarios, when a source component needs to transfer a data packet (e.g., flits) to a destination component over VC1, the credit manager 312 may check if there are dedicated credits available for VC1. If there are three dedicated credits available for VC1, the credit manager 312 may decrement this by one and make it as availability of 2 dedicated credits. If there are no dedicated credits left for VC1, the credit manager 312 may decrement the shared credits by one and increment the used shared credits for VC1 by one. If there are initially 10 shared credits and VC1 has used none, after this operation, there may be 9 shared credits left and the used shared credits may be incremented to 1.

FIGS. 5B-5D illustrate a process of returning the credits to the specific VC. Referring to FIG. 5B, at 502B, the credit manager 312 may check whether the dedicated credits associated with the VC are less than predefined maximum dedicated credits (ded[VC]<max_ded[VC]) or not. If the dedicated credits associated with the VC are less than the predefined maximum dedicated credits, the credit manager 312 may increment the dedicated credits associated with the VC, as represented at 504B. If the dedicated credits associated with the VC are greater than the predefined maximum dedicated credits, the credit manager 312 may increment the shared credits associated with the VC, as represented at 506B. For example, in some scenarios, when a processing unit initiates a data read request to a memory unit and if VC1 is handling the data read request from the memory unit, the credit manager 312 may evaluate a current state of the dedicated credits. If the dedicated credits (ded[VC]) are less than the maximum allowable dedicated credits (max_ded[VC]), the credit manager 312 may increment the dedicated credits associated with the VC1. This increment may allow the VC1 to handle more flits from the memory unit. If the dedicated credits associated with the VC1 are greater than the predefined maximum dedicated credits (e.g., the VC1 has reached its limit of dedicated resources), the credit manager 312 may increment the shared credits associated with the VC1. In an embodiment, the shared credits may represent a pool of resources that can be dynamically allocated to VCs based on current needs.

Referring to FIG. 5C, at 502C, the credit manager 312 may check whether the shared credits associated with the VC are used or not (shared_used[VC]>0). If the shared credits associated with the VC are used, the credit manager 312 may increment the shared credits and decrement the used shared credits associated with the VC, as represented at 504C. If the shared credits associated with the VC are not used, the credit manager 312 may increment the dedicated credits associated with the VC, as represented at 506C. For example, in some scenarios, when the source component is transmitting the flits to the destination component, the credit manager 312 may monitor the credit status to manage the flow of data efficiently. If the shared credits associated with the VC are used, the credit manager 312 may increment the shared credits, and simultaneously decrement the used shared credits associated with the VC, as represented at 504C. If the shared credits associated with the VC are not used, the credit manager 312 may increment the dedicated credits associated with the VC, as represented at 506C.

Referring to FIG. 5D, at 502D, the credit manager 312 may check whether the VC is locked and dedicated credit count is zero or not (is_locked[VC] and ded[VC]==0). If the VC is locked and dedicated credit count is zero, the credit manager 312 may increment the dedicated credits associated with the VC, as represented at 504D. If the VC is not locked and dedicated credit count is not zero, the credit manager 312 may check whether the used shared credits associated with the VC are available or not (shared_used[VC]>0), as represented at 506D. If the used shared credits associated with the VC are available, the credit manager 312 may increment the shared credits and decrement the used shared credits associated with the VC, as represented at 506E. If the used shared credits associated with the VC are unavailable, the credit manager 312 may increment the dedicated credits associated with the VC, as represented at 506F. For example, in some scenarios, when the source component transmits the flits to the destination components, the credit manager 312 may check if the VC is locked and if its dedicated credit count is zero. If the VC is locked and has no dedicated credits available, the credit manager 312 may increment the dedicated credits associated with the VC. Alternatively, if the VC is not locked and its dedicated credit count is non-zero, the credit manager 312 may verify the availability of shared credits associated with the VC. If shared credits are available, the credit manager 312 may increment the shared credits and reduce the used shared credits for the VC. In cases where shared credits are not available, the credit manager 312 may increment the dedicated credits associated with the VC.

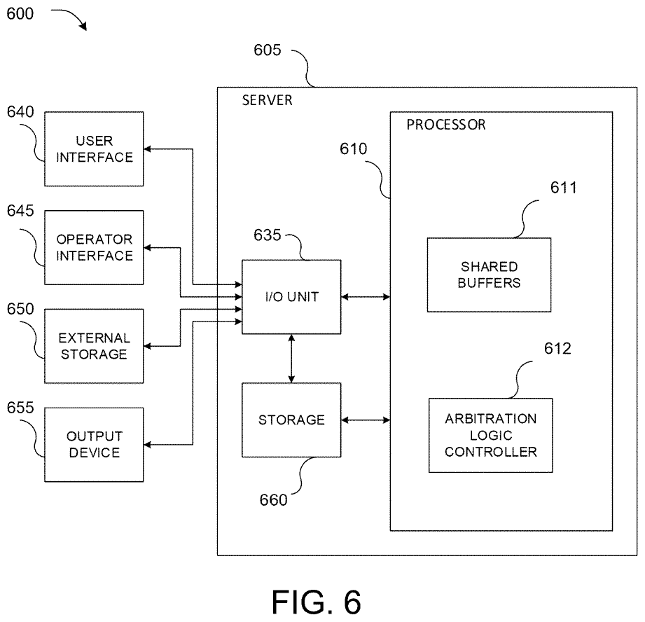

FIG. 6 illustrates an example computer system 600 on which example embodiments may be implemented. The computer system 600 includes a server 605 which may include an I/O unit 635, storage 660, and a processor 610 operable to execute one or more units as known to one of skill in the art. The term “computer-readable medium” as used herein refers to any medium that participates in providing instructions to processor 610 for execution, which may come in the form of computer-readable storage mediums, such as, but not limited to optical disks, magnetic disks, read-only memories, random access memories, solid state devices and drives, or any other types of tangible media suitable for storing electronic information, or computer-readable signal mediums, which can include transitory media such as carrier waves. The Input/Output (I/O) unit 635 processes input from user interfaces 640 and operator interfaces 645 which may utilize input devices such as a keyboard, mouse, touch device, or verbal command.

The server 605 may also be connected to an external storage 650, which can contain removable storage such as a portable hard drive, optical media (CD or DVD), disk media, or any other medium from which a computer can read executable code. The server may also be connected to an output device 655, such as a display to output data and other information to a user, as well as request additional information from a user. The connections from the server 605 to the user interface 640, the operator interface 645, the external storage 650, and the output device 655 may be via wireless protocols, such as the 802.11 standards, Bluetooth® or cellular protocols, or via physical transmission media, such as cables or fiber optics. The output device 655 may therefore further act as an input device for interacting with a user. The processor 610 may execute one or more modules. The processor 610 may include shared buffers 611 and an arbitration logic controller 612. The shared buffers 611 may be configured to manage the arriving flits with a plurality of logical queues, each of the plurality of logical queues managing the arriving flits according to a virtual channel of the input port (e.g., 304) associated with the arriving flits and an output port (e.g., 310) corresponding to the arriving flits. The arbitration logic controller 612 may output arbitration of flits from the plurality of logical queues from a first set of arbitration logic (e.g., 308A) to the second set of arbitration logic (e.g., 308B). In an embodiment, the first set of arbitration logic 308A may arbitrate per input port and per output port. Further, the arbitration logic controller 612 may arbitrate output flits from the first set of arbitration logic 308A to the output port through the second set of arbitration logic 308B. In an embodiment, the second set of arbitration logic 308B may arbitrate per output port 310 among flits from input ports 304.

Furthermore, some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the example embodiments, the steps carried out require physical manipulations of tangible quantities for achieving a tangible result.

Moreover, other implementations of the example embodiments will be apparent to those skilled in the art from consideration of the specification and practice of the example embodiments disclosed herein. Various aspects and/or components of the described example embodiments may be used singly or in any combination. It is intended that the specification and examples be considered as examples, with a true scope and spirit of the embodiments being indicated by the following claims.

What is claimed is:

1. A Network on Chip (NoC), comprising:
a plurality of shared buffers, each of the shared buffers corresponding to each input port of a router in the NoC, each of the shared buffers configured to manage arriving flits with a plurality of logical queues, each of the plurality of logical queues configured to manage the arriving flits according to a virtual channel of the input port associated with the arriving flits and an output port associated with the arriving flits;
a first set of arbitration logic configured to output arbitration of flits from the plurality of logical queues to a second set of arbitration logic, wherein the first set of arbitration logic arbitrates per input port and per output port; and
the second set of arbitration logic configured to arbitrate output flits from the first set of arbitration logic to the output port, wherein the second set of arbitration logic arbitrates per output port among flits from the output of the first set of arbitration logic at the input port.

2. The NoC of claim 1, wherein the second set of arbitration logic is configured to begin arbitration before the first set of arbitration logic completes.

3. The NoC of claim 1, further comprising a credit manager configured to, on receipt of a return credit for a flit associated with the virtual channel:
for the return credit being associated with a locked virtual channel and for dedicated credits for the associated virtual channel being zero, increment the dedicated credits for the associated virtual channel.

4. The NoC of claim 3, wherein the credit manager is configured to:
for shared credits of the virtual channel associated with the return credit being greater than zero, increment a shared credit and decrement the shared credits of the associated virtual channel.

5. The NoC of claim 4, wherein the credit manager is configured to:
for the shared credits of the virtual channel being zero, increment a dedicated credit for the associated virtual channel.

6. A method for a Network on Chip (NoC), comprising:
managing arriving flits with a plurality of shared buffers, each of the shared buffers corresponding to each input port of a router in the NoC, each of the shared buffers configured to manage the arriving flits with a plurality of logical queues, each of the plurality of logical queues managing the arriving flits according to a virtual channel of the input port associated with the arriving flits and an output port associated with the arriving flits;
outputting arbitration of flits from the plurality of logical queues from a first set of arbitration logic to a second set of arbitration logic, wherein the first set of arbitration logic arbitrates per input port and per output port; and
arbitrating output flits from the first set of arbitration logic to the output port through the second set of arbitration logic, wherein the second set of arbitration logic arbitrates per output port among flits from the output of the first set of arbitration logic at the input port.

7. The method of claim 6, wherein the second set of arbitration logic is configured to begin arbitration before the first set of arbitration logic completes.

8. The method of claim 6, further comprising, on receipt of a return credit for a flit associated with the virtual channel:
for the return credit being associated with a locked virtual channel and for dedicated credits for the associated virtual channel being zero, incrementing the dedicated credits for the associated virtual channel.

9. The method of claim 8, further comprising:
for shared credits of the virtual channel associated with the return credit being greater than zero, incrementing a shared credit and decrementing the shared credits of the associated virtual channel.

10. The method of claim 9, further comprising:
for the shared credits of the virtual channel being zero, incrementing a dedicated credit for the associated virtual channel.
